(19) United States
(12) Patent Application Publication
(10) Pub. No.: US 2015/0202552 A1
(43) Pub. Date: Jul. 23, 2015

(54) LIQUID FILTER DRAIN WITH INTEGRAL AIR VENT

(71) Applicant: Caterpillar Inc., Peoria, IL (US)

(72) Inventors: MARK ALLOTT, MAPLETON, IL (US); DARRELL MOREHOUSE, DUNLAP, IL (US); JOSHUA L. SEELYE, WASHINGTON, IL (US)

(73) Assignee: Caterpillar Inc., Peoria, IL (US)

(21) Appl. No.: 14/161,898

(22) Filed: Jan. 23, 2014

(51) Int. Cl. B01D 29/92; F16K 27/12; B01D 35/00

(52) U.S. Cl. CPC B01D 29/92; B01D 35/005; F16K 27/12

(57) ABSTRACT

A valve stem is sized to mate with a filter housing bore. The valve stem has a first and second end and a body. The first end includes a threaded stem portion configured to mate with a corresponding threaded filter portion. The second end has a drain outlet and includes a fitting for a tube. The body has an axial passage disposed therethrough. The axial passage has a divider disposed axially along at least a portion thereof. The divider separates the axial passage into an outlet passage and a vent passage. The outlet passage is open at the first end, at the drain outlet and at a first side passage. The vent passage is closed at the first end, open at a second side passage, open at the drain outlet, and open at a vent side passage.

### TECHNICAL FIELD

This patent disclosure relates generally to a drain for a housing and, more particularly, to a liquid filter housing drain with an integral air vent.

### BACKGROUND

Liquid filter drains are known for draining filter housings of accumulated contaminants. In diesel engines, for example, a fuel line filter is used to separate out water and debris. These contaminants accumulate in a lower portion of the fuel filter housing and are periodically drained to facilitate proper function of the filter.

The drain is typically disposed at the bottom of the filter housing and opened via some type of threaded opening. However, the filter assembly and filter line connected to the filter assembly is generally otherwise a closed system. Without a vent to replace outgoing contaminants with air, the contaminants either do not flow out of the housing or, if they do, they exit the drain inefficiently in spurts. Historically, a vent screw was placed at the top of the filter base and opened to vent the drain. Alternatively, a fuel line fitting was loosened to allow air in and vent the drain. While these ‘work around’ solutions did allow air into the system, they also increased the chances of introducing contaminants into the fuel system and they required extra time and/or tools to perform.

US Publication No. 2012-0091051A1 (hereinafter “the '051 publication”), entitled “Filter Having Drain Valve with Mechanical Lock,” purports to describe a drain valve assembly with a vent. However, the drain valve assembly of the '051 publication does not provide flexibility for directing the outflow of the drain into a proper waste container. In addition, the drain valve assembly of the '051 publication does not provide venting at some angles such as if the liquid filter drain is installed at a slight angle or the vehicle is parked at a slight angle that raises the drain portion of the valve assembly higher than the vent portion of the valve assembly.

Accordingly, there is a need for an improved liquid filter drain to address the problems described above and/or problems posed by other conventional approaches.

### SUMMARY

The foregoing needs are met, to a great extent, by the present disclosure, wherein aspects of an improved liquid filter drain are provided.

In one aspect, the disclosure describes a filter housing assembly to separate water from fuel. The filter housing assembly includes a housing, fuel inlet, fuel outlet, and drain valve assembly. The housing is configured to retain a filter medium. The fuel inlet is disposed in the housing and configured to direct the fuel to a first side of the filter medium. The fuel outlet is disposed in the housing and configured to receive the fuel from a second side of the filter medium. The drain valve assembly is disposed at a lower portion of the housing to drain the water separated from the fuel out of the housing. The drain valve assembly includes a housing bore and a valve stem. The housing bore is defined by a cylindrical wall passing through the housing. The valve stem is sized to mate with the housing bore. The valve stem has a first and second end and a body. The first end includes a threaded stem portion configured to mate with a corresponding threaded filter portion. The drain valve is closed in response to the threaded stem portion being mated with the threaded filter portion and the drain valve is open in response to the threaded stem portion being unmated with the threaded filter portion. The second end has a drain outlet and includes a fitting for a tube. The body has an axial passage disposed therethrough. The axial passage has a divider disposed axially along at least a portion thereof. The divider separates the axial passage into an outlet passage and a vent passage. The outlet passage is open at the first end, at the drain outlet and at a first side passage. The vent passage is closed at the first end, open at a second side passage, open at the drain outlet, and open at a vent side passage.

In another aspect, the disclosure describes a drain valve assembly. The drain valve assembly includes a housing bore and a valve stem. The housing bore is defined by a cylindrical wall passing through the housing. The valve stem is sized to mate with the housing bore. The valve stem has a first and second end and a body. The first end includes a threaded stem portion configured to mate with a corresponding threaded filter portion. The drain valve is closed in response to the threaded stem portion being mated with the threaded filter portion and the drain valve is open in response to the threaded stem portion being unmated with the threaded filter portion. The second end has a drain outlet and includes a fitting for a tube. The body has an axial passage disposed therethrough. The axial passage has a divider disposed axially along at least a portion thereof. The divider separates the axial passage into an outlet passage and a vent passage. The outlet passage is open at the first end, at the drain outlet and at a first side passage. The vent passage is closed at the first end, open at a second side passage, open at the drain outlet, and open at a vent side passage.

In yet another aspect, the disclosure describes a valve stem. The valve stem is sized to mate with the housing bore. The valve stem has a first and second end and a body. The first end includes a threaded stem portion configured to mate with a corresponding threaded filter portion. The drain valve is closed in response to the threaded stem portion being mated with the threaded filter portion and the drain valve is open in response to the threaded stem portion being unmated with the threaded filter portion. The second end has a drain outlet and includes a fitting for a tube. The body has an axial passage disposed therethrough. The axial passage has a divider disposed axially along at least a portion thereof. The divider separates the axial passage into an outlet passage and a vent passage. The outlet passage is open at the first end, at the drain outlet and at a first side passage. The vent passage is closed at the first end, open at a second side passage, open at the drain outlet, and open at a vent side passage.

### BRIEF DESCRIPTION OF THE DRAWINGS

FIG. 1 illustrates an exemplary machine, according to an aspect of the disclosure.

FIG. 2 is a cross-sectional view taken axially through a liquid filter assembly with a drain assembly in a closed conformation, according to an aspect of the disclosure.

FIG. 3 is a cross-sectional view taken axially through the liquid filter assembly with the drain assembly in an open conformation, according to an aspect of the disclosure.

FIG. 4 is an enlarged view of a portion of a valve shaft, according to an aspect of the disclosure.

### DETAILED DESCRIPTION

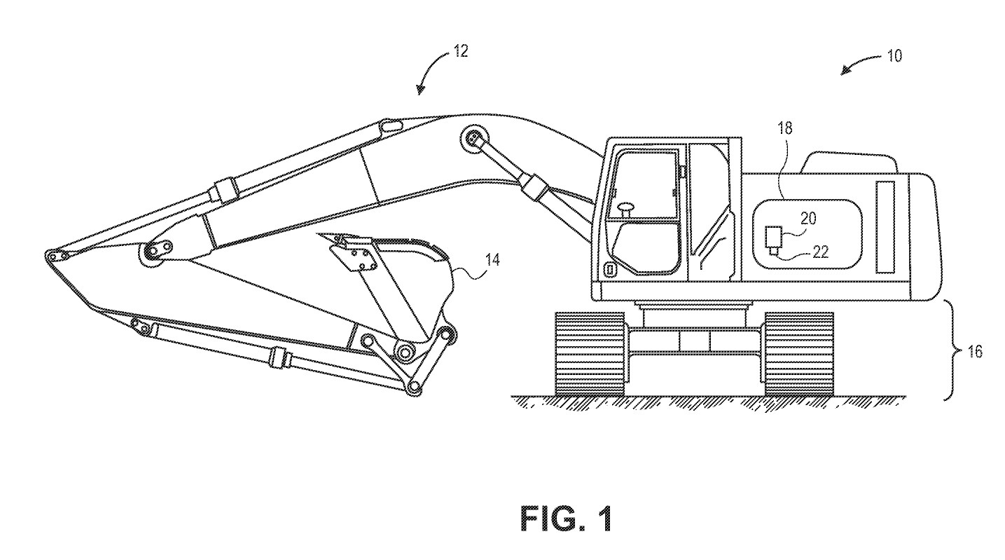

FIG. 1 illustrates an exemplary machine 10 having various systems and components that cooperate to accomplish a task. The machine 10 may embody a fixed or mobile machine that performs some type of operation associated with an industry such as mining, construction, farming, transportation, power generation, or another industry known in the art. For example, the machine 10 may be an earth moving machine such as an excavator (shown in FIG. 1), a dozer, a loader, a backhoe, a motor grader, a dump truck, or another earth moving machine. The machine 10 may include an implement system 12 configured to move a work tool 14, a drive system 16 for propelling the machine 10, a power source 18.

In a particular example, the power source 18 includes an engine configured to combust a fuel such as diesel and this fuel is filtered at a filter housing assembly 20. As fuel passes through the filter housing assembly 20, contaminants such as water, debris, and the like are filtered out and collect in the filter housing assembly 20. Periodically, these contaminants are drained from the filter housing assembly 20 at a drain valve assembly 22. For the purpose of this disclosure, the term ‘fluid’ will be used throughout to describe these contaminants, waste fluid, or contaminants suspended in fluid that are being removed from within the filter housing assembly 20. As described herein, it is an advantage of embodiments of the filter housing assembly 20 that the drain valve assembly 22 is configured to accept a hose to facilitate collecting the fluid from the filter housing assembly 20. It is another advantage of embodiments of the filter housing assembly 20 that the drain valve assembly 22 includes an integral vent to facilitate draining the filter housing assembly 20 even while attached to the hose. Of note, while particular example is made throughout of filtering and separating water from fuel, the various embodiments are not limited to filtering and collecting water from fuel, but rather, include any suitable filtering application in which the housing includes a drain. Examples of suitable filtering applications include hydraulic, lubricant, air, or other such filtration systems. Moreover, the drain valve assembly 22 may be utilized to remove standing fluid residing in the housing assembly 20 prior to the housing 30 being removed from the filter base (not shown) to replace the filter medium 38.

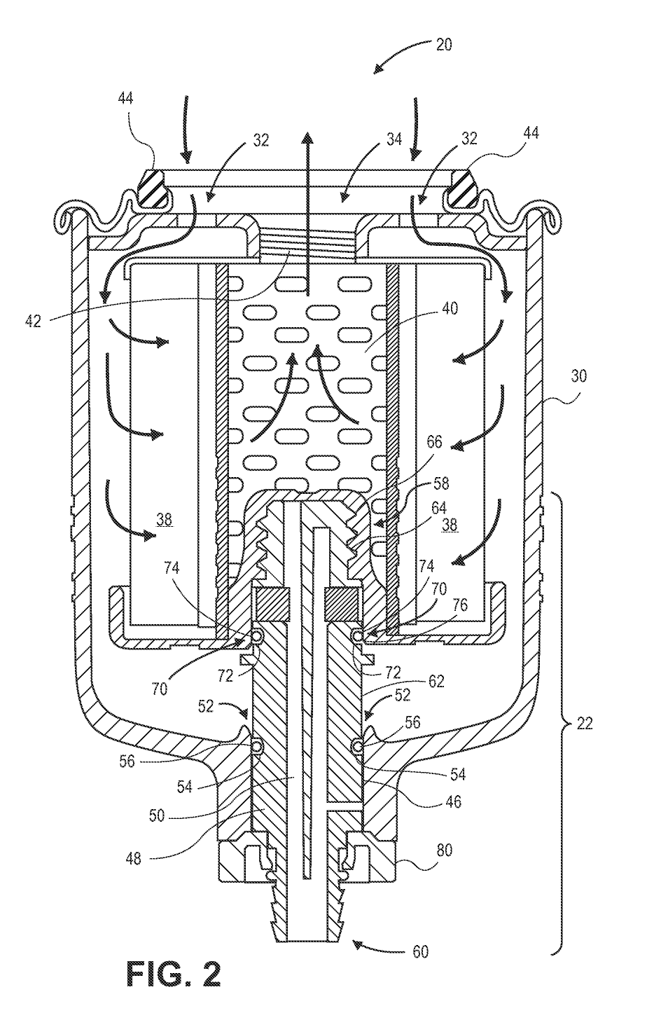

FIG. 2 is a cross-sectional view taken axially through the filter housing assembly 20 with the drain valve assembly 22 in a closed conformation, according to an aspect of the disclosure. As shown in FIG. 2, the filter housing assembly 20 includes a housing 30, fuel inlet 32, fuel outlet 34, and the drain valve assembly 22. The housing 30 is configured to retain a filter medium 38. In general, the housing 30 may include any suitable material such as, for example, metals, plastics, elastomers, and the like. In a particular example, the housing 30 is primarily sheet metal formed into a cylindrical shell and incorporating elastomeric seals. In another particular example, the housing 30 is a cast metal shell to which machined surfaces are subsequently milled and/or elastomeric seals are later added.

The fuel inlet 32 is disposed in the housing 30 and configured to direct the fuel to a first side of the filter medium 38. In the example shown, the fuel inlet 32 is actually a series of openings disposed about a top portion of the housing 30 in a manner generally known to those skilled in the art. As shown by the arrows indicating flow of the fuel, the fuel is directed towards the perimeter of the housing 30 and then through the filter medium 38 towards and interior chamber 40. Thereafter, the fuel flows out the fuel outlet 34. The fuel outlet 34 is disposed in the housing 30 and configured to receive the fuel from a second side of the filter medium 38. The fuel outlet 34 includes a threaded portion 42 configured to mate with a corresponding threaded nipple on a fuel system of the power source 18 shown in FIG. 1. To prevent or reduce leaks between the fuel system and the filter housing assembly 20, the housing 30 includes an elastomeric gasket 44 disposed about the fuel inlet 32.

The drain valve assembly 22 is disposed at a lower portion of the housing 30 to drain the fluid separated from the fuel out of the housing 30. The drain valve assembly 22 includes a housing bore 46 and a valve stem 48. The housing bore 46 is defined by a cylindrical wall 50 passing through the housing 30. This cylindrical wall 50 is sufficiently smooth and long enough to slidingly seal with a lower seal 52 disposed on the valve stem 48 over the travel of the valve stem 48 from the closed position to an open position. The lower seal 52 includes any suitable type of seal such as, for example, a friction fit, O-ring seal, or the like. In a particular example, the lower seal 52 includes an annular groove 54 disposed about the valve stem 48 and sized to accept an elastomeric O-ring 56.

The valve stem 48 is generally sized to mate with the housing bore 46 at a relatively close tolerance while allowing rotation and/or a sliding motion of the valve stem 48 within the housing bore 46. The valve stem 48 has a first end 58, a second end 60 and a body 62. The first end 58 is disposed within the housing 30 and includes a catch or latch such as a ‘ball and detent catch’ or a friction fitting or other such device to selectively retain the valve stem 38 in an open or closed position. In a particular example, the first end 58 includes a threaded stem portion 64 configured to mate with a corresponding threaded filter portion 66. The drain valve assembly 22 is shown in the closed position in FIG. 2. In general, the closed position seals the drain valve assembly 22 to allow for the normal filtering operation of filter housing assembly 20 and the operation of the power source 18 shown in FIG. 1. This sealing conformation may be accomplished in any suitable manner. In the particular example shown in FIG. 2, the closed position is accomplished in response to the threaded stem portion 64 being mated (e.g., threaded into) with the threaded filter portion 66. In addition to the mating of the threads, an upper seal 70 may be configured to reduce or stop a flow of fluid when in the closed conformation. Again, this upper seal may be accomplished in any suitable manner. In the particular example shown, an annular groove 72 is sized to accept an elastomeric O-ring 74 and the O-ring 74 is configured to form a seal when compressed between the annular groove 72 and a sealing surface 76.

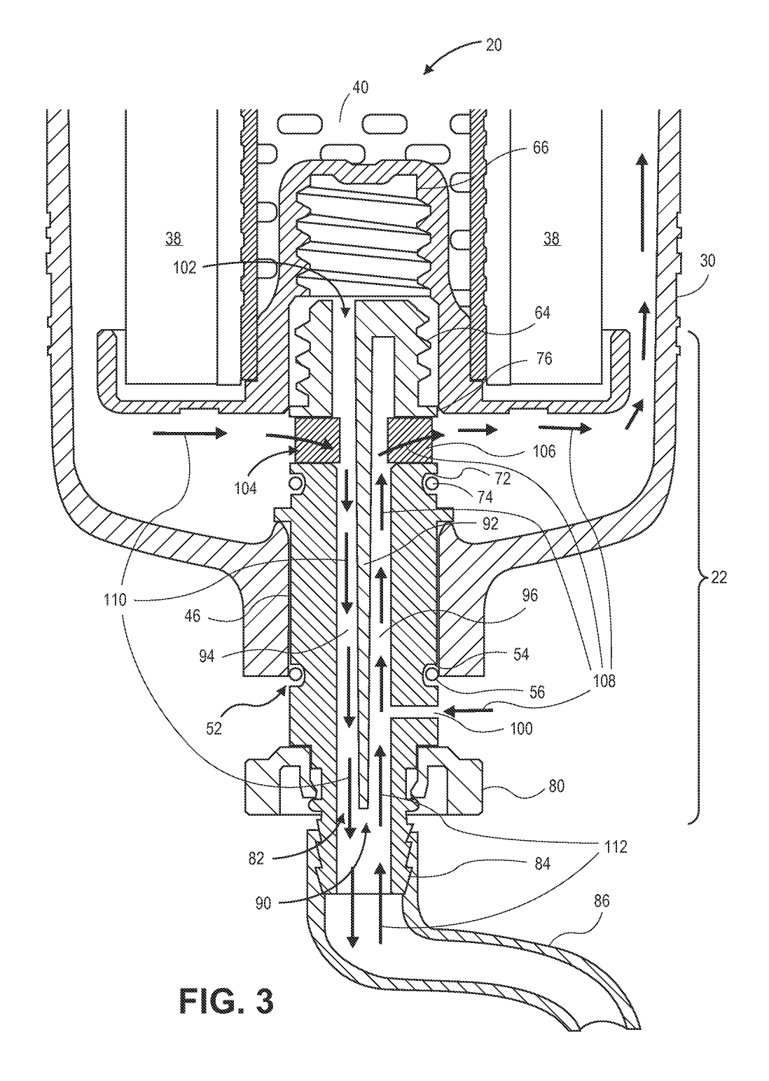

FIG. 3 is a cross-sectional view taken axially through the filter housing assembly 20 with the drain valve assembly 22 in an open conformation, according to an aspect of the disclosure. As shown in FIG. 3, the drain valve assembly 22 is opened in response to the threaded stem portion 64 being unmated with the threaded filter portion 66. To open the drain valve assembly 22, the valve stem 48 may be rotated via a user or other service technician rotating a knob 80. The knob 80 is affixed to the valve stem 48.

Once the drain valve assembly 22 is opened, a series of passages for the release of fluid and the ingress of air are opened between the interior of the housing 30 and the outside. These opening includes a drain outlet 82 disposed at the end of the second end 60. To facilitate collecting the fluid as well as an incidental amount of fuel, the drain outlet 82 includes a fitting 84 for a tube 86. In this regard, the filter housing assembly 20 is often disposed within the body of the machine 10 and relatively close to the power source 18 shown in FIG. 1. In order to prevent fluid from the drain outlet 82 spilling into the machine 10 or onto the power source 18, the tube 86 may be fitted to the fitting 84 and run to a desired location such as a waste receptacle. To help secure the tube 86 to the fitting 84, the fitting 84 may include one or more barbs 88 or other such structure such as ridges, grooves, or the like.

To continue, the body 62 has an axial passage 90 disposed therethrough. The axial passage 90 has a divider 92 disposed axially along at least a portion thereof. The divider 92 separates the axial passage 90 into an outlet passage 94 and a vent passage 96. In various examples, the divider 92 extends the entire length of the axial passage 90 or a portion of the length of the axial passage 90. In the particular example shown, the divider 92 extends a portion of the length of the axial passage 90 and stops at about the beginning of the fitting 84. However, in general, the divider 92 does extend past a vent side passage 100 the axial passage 90. This vent side passage 100 is configured to allow air into the vent passage 96 while reducing or preventing liquid from exiting out of the vent side passage. It is an advantage that this vent side passage 100 is distinct from the drain outlet 82 because fitting the tube 86 to the fitting 84 may otherwise reduce the ability of vent gases to travel back up through the drain outlet 82.

To continue, the outlet passage 94 is open at an inlet 102 disposed at the first end 58, at the drain outlet 82 and at a first side passage 104. The vent passage 96 is closed at the first end 58 in order to help direct the flow of vent gases into the housing 30 via a second side passage 106 as shown by a plurality of air flow arrows 108. The vent passage 96 is also open at the drain outlet 82 and the vent side passage 100. In operation, unscrewing the valve stem 48 via the knob 80 unthreads the threaded stem portion 64 from the threaded filter portion 66. As the valve stem 48 moves downward or outward from the housing 30, the upper seal 70 is opened and the first and second side passages 104 and 106 are drawn down into the lower portion of the housing 30 where the fluid has collected. Gravity works to urge the fluid into the first and second side passages 104 and 106 and a small vacuum pressure then draws air into the vent side passage 100, up the vent passage 96 and out the second side passage 106 to enter the housing 30 as shown by the air flow arrows 108. The replacement vent air then allows the fluid to continue flowing into the first passage 104, down the outlet passage 94 and out the drain outlet 82 as shown by a plurality of fluid flow arrows 110. Of note, if vent gas is available to be drawn up from the drain outlet 82, this vent gas is drawn up along the vent passage 96 as shown by the air flow arrows 112. In addition, at all times and particularly near the end of the draining process, the second side passage 106 and vent passage 96 are available for draining fluid. This dual functionality of the vent passage 96 is self-regulated in response to the amount of vent gas needed to replace outgoing fluid and increases the efficiency with which the fluid exits the housing 30.

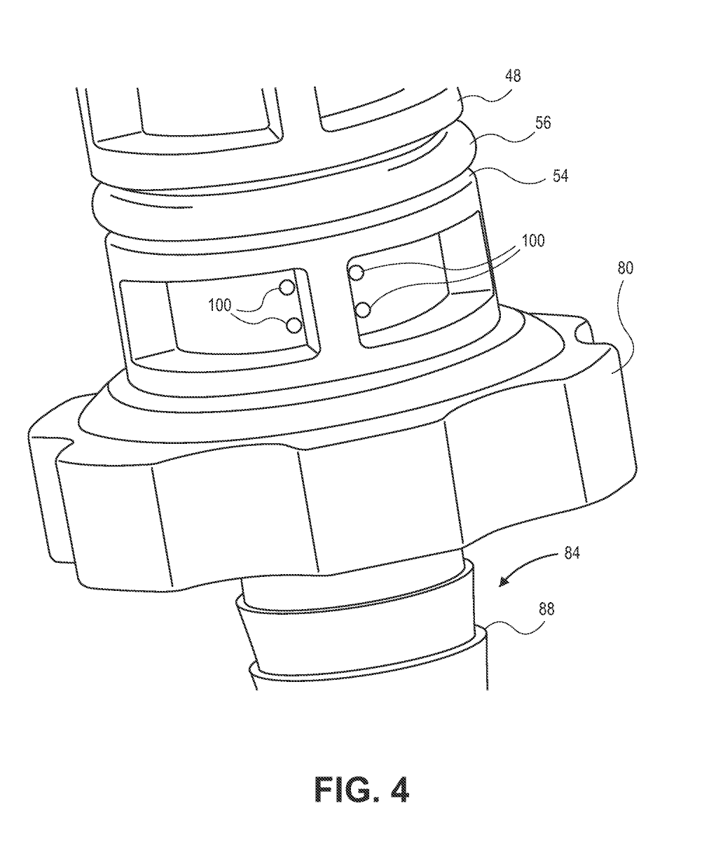

FIG. 4 is an enlarged view of a portion of a valve stem 48, according to an aspect of the disclosure. As shown in FIG. 4, the vent side passage 100 may include a plurality of vent side passages 100. It is an advantage that the plurality of vent side passages 100 are relatively small. In various embodiments, the size of each vent side passage 100 is selected to minimize the egress of fluid from the vent passage 96 through the vent side passages 100. For example, the vent side passages 100 are each not so small as to wick fluid from inside the vent passage 96 via capillary action but are small enough to have the surface tension of fluid create an impediment to the fluid's entry into the vent side passages 100 from the vent passage 96. As such, the sizing of the vent side passages 100 are selected to discourage liquid from exiting the vent side passages 100. The number of the vent side passages 100 is selected based on the total cross sectional area calculated to allow sufficient vent air into the housing. As such, the number of the vent side passages 100 may vary according to a variety of factors such as, for example, volume in the housing 30, cross sectional area of the outlet passage 94, empirical data, and the like. In the particular example shown, four of the vent side passages 100 have been determined to provide sufficient vent gas. However, in other examples, one, two, three, five, or more of the vent side passages 100 may be included.

### INDUSTRIAL APPLICABILITY

The present disclosure may be applicable to any machine including a fluid filter housing assembly having a drain. Aspects of the disclosed filter housing assembly may promote ease of use, greater ability to collect fluid, operational flexibility, and performance of fluid filter housing assemblies in general and fuel systems in particular.

Applicants discovered that a conventional approach of drawing in vent gases from a drain outlet did not provide sufficient venting in general and was particularly problematic when using a hose to collect fluid.

According to an aspect of the disclosure shown in FIG. 3, vent gases may enter the vent passage 96 via the vent side passages 100 as well as the drain outlet 82. The respective ingress of these vent gases via the different inlets is self-regulated based on the amount of fluid exiting the housing 30. The respective ingress of these vent gases via the different inlets may also be self-regulated based on whether or not the tube 86 is affixed to the fitting 84 and, if so, whether or not the tube 86 is sufficiently large enough for vent gases to be present in the tube 86 or not.

According to an aspect of the disclosure shown in FIG. 3, fluid may exit the housing 30 via the outlet passage 94 and/or the vent passage 96. The respective flow of these fluids out of the outlet passage 94 and/or the vent passage 96 is self-regulated based on the amount of fluid exiting the housing 30 and head space within the housing 30. That is, when sufficient head space is present in the housing 30 and the flow of fluid out of the housing 30 is relatively low, the fluid may exit from both the outlet passage 94 and the vent passage 96 and this increases the efficiency with which this terminal flow exits the housing 30. Again, this self-regulating flow may automatically adjust based on whether or not the tube 86 is affixed to the fitting 84 and the diameter of the tube 86.

Accordingly, aspects of the disclosure enable ease of using a drain in a filter housing assembly, greater ability to collect fluids, operational flexibility, and performance of fluid filter housing assemblies in general and fuel systems in particular.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Throughout the disclosure, like reference numbers refer to similar elements herein, unless otherwise specified.

We claim:

1. A filter housing assembly to separate water from fuel, the filter housing assembly comprising:
a housing configured to retain a filter medium;
a fuel inlet disposed in the housing and configured to direct the fuel to a first side of the filter medium;
a fuel outlet disposed in the housing and configured to receive the fuel from a second side of the filter medium; and
a drain valve assembly disposed at a lower portion of the housing to drain the water separated from the fuel out of the housing, the drain valve assembly including:
a housing bore defined by a cylindrical wall passing through the housing; and
a valve stem sized to mate with the housing bore, the valve stem having:
a first end including a threaded stem portion configured to mate with a corresponding threaded filter portion, wherein the drain valve is closed in response to the threaded stem portion being mated with the threaded filter portion and the drain valve is open in response to the threaded stem portion being unmated with the threaded filter portion;
a second end having a drain outlet and including a fitting for a tube; and
a body having an axial passage disposed therethrough, the axial passage having a divider disposed axially along at least a portion thereof, the divider separating the axial passage into an outlet passage and a vent passage, the outlet passage being open at the first end, at the drain outlet and at a first side passage, the vent passage being closed at the first end and open at a second side passage, open at the drain outlet, and open at a vent side passage.

2. The filter housing assembly according to claim 1, further comprising:
a knob disposed about the body and proximal to the fitting.

3. The filter housing assembly according to claim 1, further comprising:
a first seal to seal the first end proximal to the threaded filter portion in response to the threaded stem portion being mated with the threaded filter portion, the first seal including:
a first groove disposed annularly about the body proximal to and below the first side passage and second side passage;
a first O-ring seated in the first groove.

4. The filter housing assembly according to claim 3, further comprising:
a second seal to slidingly seal the body in a housing bore defined by a cylindrical wall passing through a housing of a filter housing assembly, the second seal including:
a second groove disposed annularly about the body proximal to and above the vent passage;
a second O-ring seated in the second groove.

5. The filter housing assembly according to claim 4, further comprising:
an outwardly protruding stop disposed annularly about the body to prevent the valve stem from sliding out of the housing bore.

6. The filter housing assembly according to claim 1, wherein the side vent passage includes a plurality of side vent passages, each side vent passage of the plurality of side vent passages being less than one quarter the cross sectional area of the vent passage.

7. A machine comprising the filter housing assembly according to claim 1.

8. The machine according to claim 7, wherein the machine is an excavator.

9. The machine according to claim 7, wherein the machine is a vehicle.

10. A drain valve assembly, comprising:
a drain valve assembly disposed at a lower portion of the housing to drain the water separated from the fuel out of the housing, the drain valve assembly including:
a housing bore defined by a cylindrical wall passing through the housing;
a valve stem sized to mate with the housing bore, the valve stem having:
a first end including a threaded stem portion configured to mate with a corresponding threaded filter portion, wherein the drain valve is closed in response to the threaded stem portion being mated with the threaded filter portion and the drain valve is open in response to the threaded stem portion being unmated with the threaded filter portion;
a second end having a drain outlet and including a fitting for a tube; and
a body having an axial passage disposed therethrough, the axial passage having a divider disposed axially along at least a portion thereof, the divider separating the axial passage into an outlet passage and a vent passage, the outlet passage being open at the first end, at the drain outlet and at a first side passage, the vent passage being closed at the first end and open at a second side passage, open at the drain outlet, and open at a vent side passage.

11. The filter housing assembly according to claim 10, further comprising:
a knob disposed about the body and proximal to the fitting.

12. The filter housing assembly according to claim 10, further comprising:
a first seal to seal the first end proximal to the threaded filter portion in response to the threaded stem portion being mated with the threaded filter portion, the first seal including:
a first groove disposed annularly about the body proximal to and below the first side passage and second side passage;
a first O-ring seated in the first groove.

13. The filter housing assembly according to claim 12, further comprising:
a second seal to slidingly seal the body in a housing bore defined by a cylindrical wall passing through a housing of a filter housing assembly, the second seal including:
a second groove disposed annularly about the body proximal to and above the vent passage;
a second O-ring seated in the second groove.

14. The filter housing assembly according to claim 13, further comprising:
an outwardly protruding stop disposed annularly about the body to prevent the valve stem from sliding out of the housing bore.

15. The filter housing assembly according to claim 10, wherein the side vent passage includes a plurality of side vent passages, each side vent passage of the plurality of side vent passages being less than one quarter the cross sectional area of the vent passage.

16. A valve stem, comprising:
a valve stem sized to mate with the housing bore, the valve stem having:
a first end including a threaded stem portion configured to mate with a corresponding threaded filter portion, wherein the drain valve is closed in response to the threaded stem portion being mated with the threaded filter portion and the drain valve is open in response to the threaded stem portion being unmated with the threaded filter portion;
a second end having a drain outlet and including a fitting for a tube; and
a body having an axial passage disposed therethrough, the axial passage having a divider disposed axially along at least a portion thereof, the divider separating the axial passage into an outlet passage and a vent passage, the outlet passage being open at the first end, at the drain outlet and at a first side passage, the vent passage being closed at the first end and open at a second side passage, open at the drain outlet, and open at a vent side passage.

17. The valve stem according to claim 16, further comprising:
a knob disposed about the body and proximal to the fitting.

18. The valve stem according to claim 16, further comprising:
a first seal to seal the first end proximal to the threaded filter portion in response to the threaded stem portion being mated with the threaded filter portion, the first seal including:
a first groove disposed annularly about the body proximal to and below the first side passage and second side passage;
a first O-ring seated in the first groove.

19. The valve stem according to claim 18, further comprising:
a second seal to slidingly seal the body in a housing bore defined by a cylindrical wall passing through a housing of a filter housing assembly, the second seal including:
a second groove disposed annularly about the body proximal to and above the vent passage;
a second O-ring seated in the second groove.

20. The valve stem according to claim 16, further comprising:
an outwardly protruding stop disposed annularly about the body to prevent the valve stem from sliding out of the housing bore.

21. The valve stem according to claim 16, wherein the side vent passage includes a plurality of side vent passages, each side vent passage of the plurality of side vent passages being less than one quarter the cross sectional area of the vent passage.
